(19) United States
(12) Patent Application Publication
(10) Pub. No.: US 2011/0124847 A1
(43) Pub. Date: May 26, 2011

(54) METHOD FOR PREPARING CONCRETE WATER REDUCER BY GRAFTING OF LIGNOSULFONATE WITH CARBONYL ALIPHATICS

(75) Inventors: Guozhong Chen, Jiangsu (CN); Jianming Gao, Jiangsu (CN); Wei Chen, Jiangsu (CN); Shugui Song, Jiangsu (CN); Zhenhua Peng, Jiangsu (CN)

(73) Assignee: JIANGSU TMS GROUP, Zhenjing, Jiangsu (CN)

(21) Appl. No.: 12/674,645

(22) PCT Filed: May 4, 2008
(86) PCT No.: PCT/CN08/70869

§ 371 Date: Dec. 13, 2010

(30) Foreign Application Priority Data
Aug. 22, 2007 (CN) 200710130819.X

(51) Int. Cl. C08H 7/00

(52) U.S. Cl. 530/501

(57) ABSTRACT

The present invention disclosed a concrete water reducer by grafting of lignosulfonate with carbonyl aliphatics and its preparation method. A technical solution of the method is as follows: compound proportioning of the concrete water reducer (weight) is: carbonyl group aliphatics:lignosulfonate=1:(0.75-1). The said concrete water reducer by grafting of lignosulfonate with carbonyl aliphatics is prepared through following process steps: controlling the temperature of aliphatics water reducer at 95-100° C.; dropping lignosulfonate into said aliphatics water reducer; conducting graft copolymerization reaction at 95° C.-100° C. for 2-5 h and obtaining lignosulfonate modified and grafted aliphatics concrete water reducer. The method of present application is simple, low cost and friendly to environment. The water reducer has good water reducing effect and can reduce colour aberration of concrete and thus be applied broadly.

### FIELD OF THE INVENTION

The present invention relates to a concrete additive and its preparation method, and in particular a concrete water reducer by grafting of lignosulfonate with carbonyl aliphatics and its preparation method.

### BACKGROUND OF THE INVENTION

Water reducer is a kind of most frequently used concrete admixture. It can reduce unit water consumption under the condition of not affecting the workability of concrete, or improve the workability of concrete under the condition of not changing unit water consumption. It can possess the above two effects at the same time without significant changes in air content. Water reducers can be classified into six series according to the chemical composition, namely: lignin series, naphthalene sulfonate series, resin series, molasses series, humic acid series and composite series. (Xu Ying et al, Construction Material Chemistry, Chemical Industry Press, 2005, (6): 98-102). However, all the naphthalene series, melamine series, and sulfamate, aliphatics and polycarboxylate series water reducers were produced by adopting advanced chemical raw materials. Some processes use formaldehyde and industrial naphthalene, thus create serious pollution to environment and also affect the health of organisms, while some products have high cost and are inapplicable to the production of the concrete of ordinary strength grade.

Lignin represents a type of substances with common characteristics in plants. The main functional groups are phenolic hydroxyl group, benzyl hydroxyl group and carbonyl group. The quantity of these functional groups is determined by the form position and material type of lignin as well as the separation method of cellulose. When wood is boiled in a solution containing NaHSO3 and SO2 at a specific temperature and pressure, lignin will be converted into calcium lignosulfonate and dissolved. Most cellulose is not changed. It is separated and used to produce paper or other fibre products, but the hemicellulose in wood is degraded and then mixed together with other water-soluble substances into water-soluble calcium lignosulfonate. Usually, this non-cellulose mixture is called sulfite cellulose liquor. Obviously, the lignin which was obtained after treatment with NaOH solution is called “alkali lignin”; the lignin which was obtained after treatment by Na2S and sulfate method is called “sulfate lignin”, wherein including “lignin sulfide”; and the lignin which is obtained by sulfite process is mainly “lignosulfonate”.

Lignin series water reducer belongs to a kind of anionic surfactant. Lignosulfonate can reduce the surface energy of solid-liquid interface and form a monomolecular membrane with certain thickness. It plays a desirable role in moisturizing, adsorbing and dispersing cement particles. Lignosulfonate macromolecular anions are adsorbed onto the surface of cement particles and negatively charge cement particles. As a result, the cement particles repulse each other and are dispersed. Meanwhile, numerous hydrophilic groups of lignosulfonate form a solvent-based adsorption layer around cement particles, complex the metallic ions in cement paste, hinder the quick hydration and heat release of cement, retard the setting of cement paste, release the water contained in the set cement and enhance the lubricating effect among cement particles, thus improving the fluidity of cement paste. (Liang Hunan, Pulping Black Liquor Modified Concrete Water Reducer. South West Pulp and Paper 2006. Vol. 35, No. 2). However, lignin series water reducer also has its inherent defects such as low water reducing ratio, high air entraining content and serious setting retardation (particularly when dosage is excessive). In addition, lignosulfonate shows poor adaptability to some cement/admixtures. The lignosulfonate produced by a conventional method is imperfect and unstable in terms of sulfonation, selection of molecular weight range and other aspects of process, resulting in high process cost, low water reducing ratio, poor adaptability to cement, low cement paste fluidity and high bubble rate. Therefore, its application goes from bad to worse and can only be used as an assistant of water reducer. In some processes, formaldehyde and industrial naphthalene are used. This creates serious pollution to environment and also affects the health of organisms. Some products are too costly to produce the concrete of ordinary strength grade.

Black liquor is a waste liquid generated in soda pulping process. It is a major pollutant of paper mills. Generally, the solid matter of black liquor contains 65%—70% organics and 30%-35% inorganics. The organics mainly are alkali lignin, volatile organic acids and other reaction products. Alkali lignin is an anionic organic compound and contains both hydrophilic part and hydrophobic part, so it has the function of anionic surfactant. When alkali lignin is added into concrete, it can play a role in water reducing. However, alkali lignin has complex molecular composition, wide distribution of molecular weight, poor water solubility and low surface activity and also doesn't have strong hydrophilic functional groups. These have held back its application and popularization. (Tian Zhen, Qiu Xueqing, Ouyang Xinping and Yang Dongjie, Technical Study on Modification of Alkali Lignin into Cement Water Reducer through Sulfonation. Paper Science & Technology, 2001, 20(1): 27-30.)

Currently, the treatment of the waste liquid of paper pulp gives stress on the treatment and application of wood pulp and bagasse at home and abroad, but no effective means are available to treat the low-quality waste liquid of straw pulp, bamboo pulp and reed pulp. The reason is that it lacks of analysis and research on the properties of the waste liquid of these pulps at home and abroad, and the water reducer products that meet the requirements of standards can not be obtained. Paper pulp producers are still in urgent need of harmless treatment and comprehensive and efficient utilization of the waste liquid discharged by them. The lignosulfonate produced by conventional method is imperfect and unstable in terms of sulfonation, selection of molecular weight range and other aspects of process, resulting in high process cost. Furthermore, its water reducing ratio is low, cement adaptability is poor, cement paste fluidity is low and bubble rate is high. Therefore, its application goes from bad to worse and can only be used as an assistant of water reducer. Aliphatic water reducer has a high water reducing ratio, but its colour aberration is large and its color is usually sanguine. Consequently, its application in the construction sector which has high demand on color is limited and moreover, its cost is also high. The production of aliphatic water reducers needs a large amount of formaldehyde, so there is great impact on the environment.

Literature (Qiu Xueqing, doctoral dissertation, Research on the Influence of Water Reducer on the Performance of Mortar in Tunnel Shield and its Mechanism, 2006) expounds the characteristics of naphthalene series (FDN), melamine series (SMF), aliphatics (ASF) and aminosulfonic acid series (ASP) and calcium lignosulfonate water reducers (LS) and puts forth modified calcium lignosulfonate water reducer, but it fails to solve the problems of high cost, water reducing ratio and comprehensive water reducing performance.

Literature (Sun Zhenping et al, Research on the Compatibility between Polycarboxylic Acid Series High-performance Water Reducer and Common Water Reducers, the Third Annual Conference of National Committee for Concrete Admixture Application Technology and the Third National Conference for Technical Exchange of Polycarboxylic Acid Series High-performance Water Reducers and Their Application, 2007) expounds the compatibility between high-performance polycarboxylic acid series water reducer and common water reducers, but it also fails to solve the problems of high cost, water reducing ratio and comprehensive water reducing performance.

### SUMMARY OF THE INVENTION

The present invention provides a method for preparing concrete water reducer by grafting of lignosulfonate with carbonyl aliphatics. The method has a high water reducing ratio and low cost, and is also characterized by small colour aberration, environmental friendliness and desirable comprehensive performance.

### The Technical Solution of the Present Invention is as Follows:

A method for preparing concrete water reducer by grafting of lignosulfonate with carbonyl aliphatics, wherein the water reducer is obtained through graft copolymerization reaction between lignosulfonate and carbonyl aliphatic compounds.

In the above-mentioned technical solution, the weight ratio between the said carbonyl aliphatic compounds and the said lignosulfonate is 1: (0.75-1). The conditions of the said graft copolymerization reaction is dropping lignosulfonate into carbonyl aliphatic compounds to take graft copolymerization reaction at 95-100° C. for 2-5 h.

The said carbonyl aliphatic compounds are produced by the following method: mix water, anhydrous sulphite and acetone, rise in temperature to 56-100° C., drop formaldehyde into the above mixed liquor within 0.5-2 h, insulation work at 100-103° C. for 1-4 h and thus obtain carbonyl aliphatic compounds.

### Proportion of the Above-Mentioned Raw Materials:

Anhydrous sulphite is 9%-15% of the total weight of the four raw materials including water, anhydrous sulphite, acetone and formaldehyde; acetone is 9%-15% of the total weight of the said four raw materials; formaldehyde is 9%-40% of the total weight of the said four raw materials; water is 35%-65% of the total weight of the said four raw materials.

### Preparing Method of Lignosulfonate:

After pre-homogenizing black liquor of paper pulp, add oxydol and heptahydrate-ferrous sulfate, and then react at 75-85° C. for 0.5-3 h, while controlling temperature at 95-100° C., add ammonium persulfate and anhydrous sulphite, reacting for 2-5 h and thus the lignosulfonate is obtained.

### Proportion of the Above-Mentioned Raw Materials:

Black liquor of paper pulp: it is calculated based on the weight of lignin in it. Lignin is 50%-64% of the total weight of lignin, oxydol, heptahydrate-ferrous sulfate, ammonium persulfate and anhydrous sulphite; oxydol is 0.2%-0.4% of the total weight of above five materials; ferrous sulfate heptahydrate is 0.2%-0.4% of the total weight of above five materials; ammonium persulfate is 0.2%-0.4% of the total weight of above five materials; anhydrous sulphite is 35%-49% of the total weight of above five materials.

In the above-mentioned technical solution, the products obtained from the preparing of lignosulfonate and carbonyl aliphatic compounds by the above method immediately take graft copolymerization reaction under the given grafting conditions. Since the product prepared from the above process is directly used, the product is not stored for some time and the intermediate generated in the product has high reactivity, thus the efficiency of graft copolymerization reaction is high and the reaction time can be shortened as well as the water reducing ratio of the obtained product is high and the cost is further reduced.

The said anhydrous sulphite is industrial waste residue anhydrous sodium sulphite. As its price is low, the cost of the present invention can be further reduced. Moreover, as industrial waste is utilized, the cost is further reduced.

The said carbonyl aliphatic compounds preferably are sulfonated acetone formaldehyde based superplasticizer (SAF).

The said black liquor of paper pulp comes from the waste liquid of straw pulp, bamboo pulp and reed pulp. These raw materials have broad source and can further reduce the cost of the present invention.

The said black liquor of paper pulp is the thin black liquor of paper pulp directly discharged from factories. The concentration of the thin black liquor is 8%-11%. This raw material is a waste directly discharged from factories. As no further processing and treatment is needed, the cost is even lower.

The said carbonyl aliphatic compounds are the carbonyl aliphatic water reducer available in the market. The lignosulfonate is lignosulfonate modified water reducer available in the market. These two water reducers are massively produced and cheap in the market, so directly using them as raw materials can further reduce the production cost of the present invention.

The technical effects of the present invention are as follows:
1. The performance characteristics of the lignosulfonate produced in the present invention shall realize color change—from black into brown, and smell change—from stinky and fishy into non-stinky, non-fishy and woody flavor, and the technical indexes shall conform with the standard of grade 1 products as specified in GB8076-1997 Concrete Admixtures. Moreover, since the lignin in the waste liquid of paper making and other industrial wastes is effectively utilized, it has the advantages of environmental protection and low cost.
2. The new-type high-performance concrete water reducer, which is produced in the present invention by grafting the ordinary lignosulfonate produced by the above process with carbonyl aliphatic concrete water reducer, realizes 22-26% water reducing ratio of concrete. On the precondition of equal addition amount of cement and admixtures, the water reducing ratio of the new-type high-performance concrete water reducer has risen 70%-80% compared with the water reducing ratio of lignosulfonate.
3. The new-type high-performance concrete water reducer, which is produced in the present invention by grafting lignosulfonate with carbonyl aliphatic compounds, can significantly solve the problem of poor cement adaptability universally existing in original lignin water reducers, and remarkably raise cement paste fluidity.
4. Under the following conditions of graft copolymerization: reaction time of 2-5 h; reaction temperature of 95-100° C., the reactivity between the two raw materials in the present invention can be fully played, and C═C double bond can be fully opened, thus the graft reaction is more efficient. If the temperature is too low and reaction time is too short, the graft copolymerization reaction will be less efficient; however, if the temperature is too high and reaction time is too long, the product can become unstable, side reactions will increase and adversely affect the graft reaction.
5. During the production of high-performance carbonyl aliphatic concrete water reducer, as the aliphatic product obtained from the reaction of acetone, sodium sulphite and other substances is blood red (with yellow), showing a large aberration from concrete, it can hardly be accepted in industrial application, resulting in a narrow application range. By contrast, the present invention uses ordinary lignosulfonate (black) to take graft reaction with high-performance carbonyl aliphatic concrete water reducer, and effectively eliminates colour aberration. The formed water reducer is brown, so the color of the external surface of the cast concrete is brown and is close to the color of reference concrete, almost without any colour aberration. Therefore, it is easily accepted by the public and widely applied.
6. In the production of lignosulfonate and carbonyl aliphatic water reducer, the present invention utilizes industrial waste residue namely anhydrous sulphite, so the cost is greatly reduced and it is more beneficial to environmental protection; furthermore, carbonyl aliphatic water reducer is only a part of the new-type water reducer, so the use of the new-type water reducer will remarkably lessen the use of formaldehyde and decrease the pollution of formaldehyde to environment.
7. The present invention can utilize thin black liquor and the evaporated and concentrated thick black liquor with a content of 40%-50%. After pre-homogenization, sulfonation and other modifications, carbonyl aliphatic concrete water reducer is drafted with the said thin black liquor and thick black liquor to obtain a new-type high-performance concrete water reducer product. The use of the concrete water reducer prepared in the present invention can save resources and generate no waste gas and waste liquid, as well as turn wastes into resources, and thus help environmental protection and benefit the society and mankind.
8. Carbonyl aliphatic concrete water reducer alone has good compatibility with concrete, but it has large colour aberration and high cost, and thus application is narrow. Lignosulfonate alone should have a high water reducing ratio in view of its chemical composition, but due to its poor compatibility with concrete and poor fluidity, this product has manifested with poor water reducing ratio, high air entraining content and serious setting retardation (particularly when the dosage is excessive) for a long time. In addition, lignosulfonate shows poor adaptability to some cement/admixtures, so its water reduction efficiency is greatly discounted; however, the production of lignosulfonate makes effective use of the black liquor in paper making industry, greatly lowering cost and is protective to environment. The new-type water reducer obtained in the present invention through graft reaction between lignosulfonate and carbonyl aliphatic concrete water reducer overcomes the large colour aberration and high cost of carbonyl aliphatic concrete water reducer; the unique structural feature of the carbonyl aliphatic compounds introduced after graft reaction enables the new-type water reducer to overcome the poor compatibility of the original lignosulfonate with concrete and give full performance to the water reducing effect of lignosulfonate. Under equal addition amount of cement and admixtures, the water reducing ratio of the new-type water reducer after graft reaction is equivalent to the water reducing ratio of carbonyl aliphatic water reducer. In other words, compared with carbonyl aliphatic concrete water reducer, the new-type water reducer after graft reaction adopts cheaper lignosulfonate as raw material, thus remarkably lowering its cost to be 10%-15% below the cost of carbonyl aliphatic water reducer. Moreover, as its colour aberration is small, it is more widely applied.
9. In reliance on infra-red spectrum and product viscosity determination and in consideration of the characteristics of the technical process and properties of the product, the present invention creatively conducts graft polymerization between lignin and aliphatics water reducer molecules to graft the C═C double bond of aliphatics water reducer to the modified lignosulfonate, thus overcoming the inherent flaws of the two raw materials such as low water reducing ratio, poor compatibility with cement and large colour aberration.
10. Under the condition of equal dosage of water reducer, the plasticity of the grafts in the present invention is obviously better than that of common cold-combined water reducer products, and close to that of simple aliphatics water reducer. Under the condition of similar initial fluidity, the addition of the graft water reducer in the present invention shows better retentivity of paste fluidity than the addition of cold-combined water reducer, also obviously better than aliphatics water reducer. The concrete added with the graft water reducer in the present invention is superior to the concrete produced with the combination of modified black liquor of paper pulp and SAF cold-combined water reducer in water reducing ratio and compressive strength. The concrete prepared by adding the graft water reducer in the present invention as well as ground slag, fly ash and other admixtures can meet the strength requirements of C30, C40 and C50. The graft water reducer prepared in the present invention can be used as a high-performance water reducer. Moreover, after minor modification, it can also be used as a high-performance concrete pumping aid. The product can be used to prepare commercial pumped concrete of C30, C40, C50 and above C50 as well. Therefore, it realizes the aim of efficiently utilizing the waste liquid of paper pulp and reducing the consumption of petroleum products to obtain remarkable environmental, economic and social benefit.
11. In the present invention, the aliphatic has a C═C absorption peak at 1625 cm−1, while in the grafts, the C═C absorption peak (appearing position: 1680-1620 cm−1) disappears, the reaction between aliphatics and modified lignin tends become stable and the change of molecular weight is not large; the aliphatic has a chain structure, and its effective hydrodynamic volume is large and also corresponding viscosity is high, whereas when the chain structure containing C═C is grafted to the modified lignin, the chain structure will decrease and meanwhile the extent of branching of modified lignin will increase and the corresponding viscosity will decrease; in viscosity test, the viscosity of Group C is lower than that of Group B. Originally, lignosulfonate has a complex molecular structure and wide distribution of relative molecular mass. Too large relative molecular mass will result in excessive setting retardation of concrete, while too small relative molecular mass will result in increase of air entrainment and decrease of concrete strength. Therefore, one of the modification methods is to remove the components with too small or too large relative molecular mass and retaining the components with strong dispersant effect and medium relative molecular mass. Through grafting and modification into medium-size molecules in the present invention, the incompatibility of original lignosulfonate with cement is eliminated after graft reaction. Moreover, the advantage of good water reducing effect is fully performed. In alkaline environment, the remnant formaldehyde in aliphatic will condense with modified lignosulfonate to improve the water solubility of water reducer. Besides, as formaldehyde is further consumed, the character of environmental protection of the produced concrete water reducer is much more increased.
12. The present invention produces carbonyl aliphatic water reducer by using water, anhydrous sulphite and acetone to react with formaldehyde. As anhydrous sulphite (sodium) can come from industrial waste residue and acetone is very cheap, the cost of the present invention can be further reduced.
13. In the present invention, it is preferable to directly use lignosulfonate intermediate as raw material. The lignosulfonate intermediate is produced by the following method: add oxydol and ferrous sulfate heptahydrate into thin black liquor of paper pulp, react at 75-85° C. for 0.5-3 h, control temperature at 95-100° C., and add ammonium persulfate and anhydrous sulphite to react and obtain lignosulfonate intermediate. Directly using the produced lignosulfonate intermediate to produce lignosulfonate grafted carbonyl aliphatic concrete water reducer has the following advantages: oxydol and ferrous sulfate heptahydrate have strong oxidability, so the formed lignosulfonate intermediate system has very strong activity. Directly using it in the following production can give full performance to its activity, significantly enhance the efficiency of the product as a grafting tool and further improve the water reducing ability of the product; in addition, anhydrous sulfurous acid can come from industrial waste residue, so the cost can be further reduced.
14. In the present invention, the preferable source of the black liquor of paper pulp used in the production of lignosulfonate is the waste liquid of straw pulp, bamboo pulp or reed pulp. This waste liquid is ignored by most manufacturers and its discharge causes serious environmental pollution. The utilization of this waste liquid can further reduce cost and enhance environmental protection.
15. In the present invention, it is preferable to directly use the directly discharged lignin-containing thin black liquor of paper pulp without concentration, treatment or processing. This material is widely available. Its concentration is 8-11% in general. Therefore, the cost is further reduced and simultaneously desirable water reducing effect can be achieved.
16. The C═C double bond contained in the structure of carbonyl aliphatic water reducer is opened during graft reaction, so there is no special requirement on the grafted lignosulfonate. Therefore, the source of lignosulfonate can be very wide and the profusely discharged thin black liquor of paper pulp (its concentration generally is 8%-11%) can be adopted. The cost will be reduced on a large margin; the cost of carbonyl aliphatic water reducer is low, too. It can further reduce the cost of the present invention. As raw material can be selected from a wide range, the selection range of lignosulfonate is wide and cost is even lower. Furthermore, the present invention can also use lignosulfonate water reducer (or the product prepared through modification of it) and carbonyl aliphatic water reducer available in market as raw materials. As these two raw materials have been commercialized, their cost is low, in particular lignosulfonate water reducer. When it is used as a raw material of the graft copolymerization reaction, the cost can be further reduced on a margin of above 20%.

### Principles of the Present Invention:

First of all, the thin black liquor discharged from paper mills during paper pulping is utilized. Under the controlled temperature and time, it is homogenized, sulfonated and modified into ordinary lignosulfonate. Its performance characteristics are changed, for example color changes from black into brown, and smell changes from stinky into woody flavor.

The present invention uses the modified ordinary lignin water reducer to draft carbonyl aliphatic concrete water reducer. The key is:

The sulfonation and modification of lignin, i.e.: introducing lyophilic group—sulfo group into lignin macromolecules to generate lignosulfonate. In the present invention, it is added after the condensation of carbonyl aliphatic compounds (corresponding to the technical solution of the present invention, lignosulfonate is dropped into carbonyl aliphatic compounds). This facilitates the first formation of the long-chain carbonyl aliphatic compounds, thus the water reducing effect of carbonyl aliphatic compounds can be more effectively performed and the water reducing ratio becomes even higher. Otherwise, the water reducing ratio will be low and the colour aberration will be large and also the compatibility between water reducer and cement will be poor; the key of grafting process is the control of temperature and time. The time and temperature have large influence on grafting effect. If the time is too short, grafting efficiency will be low and it will be difficult to realize a high overall water reducing ratio; if the time is too long, on the one hand, production efficiency will be low and on the other hand, the quantity of carbonyl groups and other active groups will decrease, thus reducing water reducing ratio; too low temperature has no good for reaction and results in low production efficiency; too high temperature can result in instability of graft compound, thus reducing water reducing ratio. The process flow of graft polymerization is: after pre-homogenization of the black liquor of paper pulp, the lignosulfonate intermediate is generated through sulfonation, and then the intermediate conducts draft copolymerization with the produced aliphatics water reducer to obtain lignosulfonate modified and grafted aliphatics concrete water reducer; wherein the material proportioning and parameters are given in embodiments. The technical parameters after grafting meet the requirements of GB8076-1977 Concrete Admixtures.

Polycondensation is realized through the condensation reaction of lignosulfonate with such monomers as formaldehyde, phenol and isocyanate. Lignosulfonate can not only substitute phenols to react with formaldehyde under alkaline catalyst but also be used as aldehyde to take condensation reaction with phenols under acidic catalyst.

The present invention improves the synthesis process of lignosulfonate, which attaches importance to the separation of the reducing sugar in the product, and thus develops and produces a modified lignosulfonate product with high purity, low sugar and no precipitation, which has a high water reducing ratio, low air entraining content, weak setting retardation and good compatibility with cement after it is added into concrete. More importantly, the present invention studies and develops the grafting of aliphatics water reducer by using lignin-containing waste liquid of paper pulp. This effectively utilizes the waste liquid of paper pulp and provides an important method for the comprehensive utilization of the waste liquid of paper pulp and environmental protection.

The present invention provides a method producing a new-type high-performance concrete water reducer by utilizing the thin black liquor discharged during paper making (the black liquor is not evaporated and concentrated) with a concentration of about 8%-11% and grafting carbonyl aliphatic concrete water reducer after sulfonation and modification. The lignin in the black liquor of soda pulping process exists in form of alkali. When the effective alkali content in the black liquor is greater than 1.14%, alkali lignin will be thoroughly dissolved into the black liquor and exist in form of hydrophilic gel and no sedimentation will happen, where as a when the effective alkali content is less than 0.71%, alkali lignin colloid will be partially destroyed and the sedimentation will occur. Due to the existence of hydrophilic groups of alkali lignin, the black liquor has certain activity, but the effect is unstable. Therefore, if the waste liquid of alkali lignin paper pulp is utilized to produce water reducer, sulfo group, amine group, carbonyl group and other anionic surfactant groups must be introduced for modification. Lignin can easily react with sulfurous acid, sulphite and other sulfonating agents to generate lignosulfonate. The reaction principle is: sulfurous acid takes addition reaction with the enol groups in lignin molecules to introduce sulfo groups. The reagent that introduces sulfo groups is Na2SO3. Na2SO3 is hydrolyzed into H2S03 to ensure the continuity of the addition reaction and thus lignosulfonate is generated in alkaline medium.

### BRIEF DESCRIPTION OF THE DRAWINGS

FIG. 1 Process flow diagram for producing high-performance concrete water reducer by modifying and grafting the black liquor of paper pulp with carbonyl aliphatic compounds according to the present invention

FIG. 2 Infra-red spectrum of black liquor of paper pulp

FIG. 3 Infra-red spectrum of modified lignin

FIG. 4 Infra-red spectrum of aliphatics concrete water reducer

FIG. 5 Infra-red spectrum of lignin grafted with carbonyl aliphatic water reducer

FIG. 6 Loss of paste fluidity of “CONCH” cement in 0.5 h

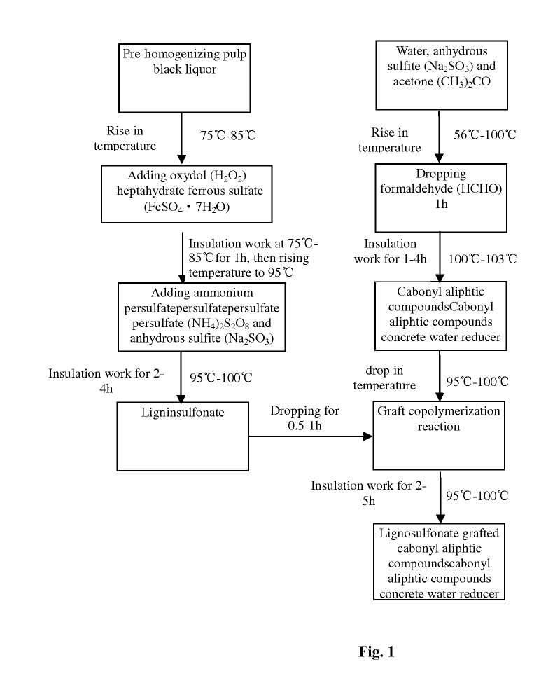

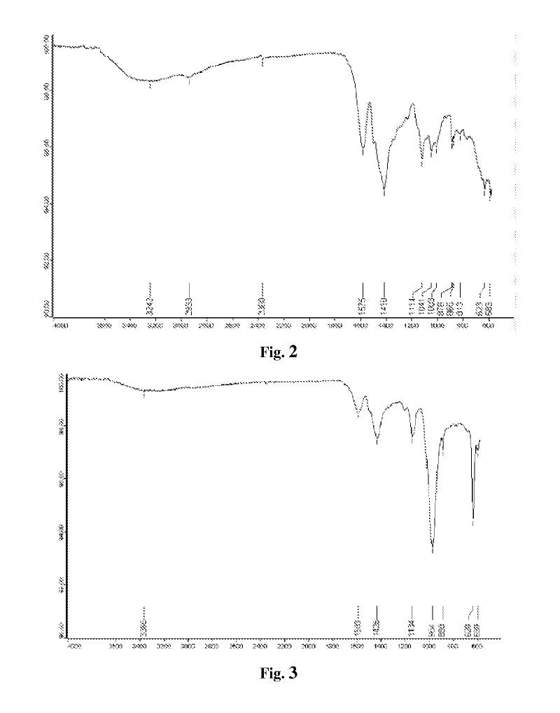

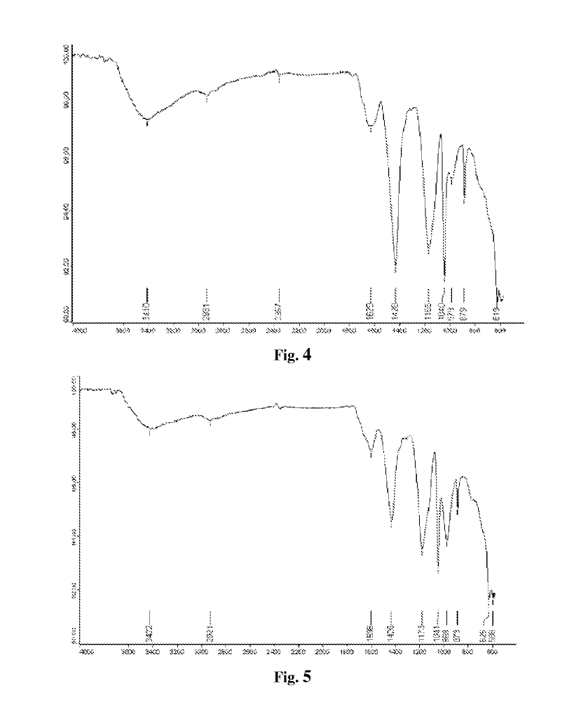

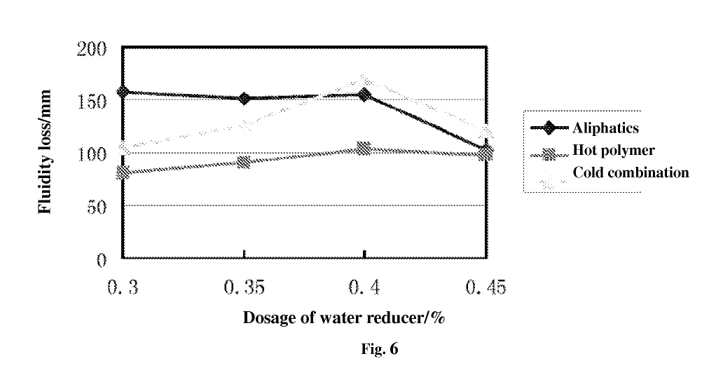

### DETAILED DESCRIPTION OF THE EMBODIMENTS

In order that the examiner and the public could further understand the essence and positive effect of the present invention, the applicant gives detailed description in form of specific embodiments, but in no case, the embodiments shall be deemed as limitations to the technical solution of the present invention.

### Embodiment 1

A method for producing concrete water reducer by grafting of lignosulfonate with carbonyl aliphatic compounds, wherein the concrete water reducer is obtained through graft copolymerization reaction between lignosulfonate and carbonyl aliphatic compounds.

Two raw materials, namely lignosulfonate and carbonyl aliphatic compounds can be obtained through synthesis or purchased from the market, For example, calcium lignosulfonate is produced by Jilin Chenming Group and carbonyl aliphatic compounds series water reducer is produced by Jiangsu TMS Comcrete Addition Agent Co., Ltd. The carbonyl aliphatic water reducer mainly refers to the SAF synthesized from acetone, sulphite and formaldehyde. Its structural feature is that the main chain of hydrophobic group is aliphatic hydrocarbon, while the hydrophilic groups mainly include —SO3H, —COOH and —OH and specifically include all aliphatic carbonyl compounds mentioned in the Complete Collection of Chemical Raw Materials (Edition 2) (Vol. 2) (Wei Wende, Chemical Industry Press, 2003). For example, the structural formula of a typical SAF molecule is as follow:

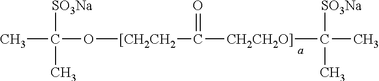

The raw materials of SAF are cheap and the preparation process is simple (synthesis temperature is at 80-100° C.), so the cost of the synthesis is relatively low and the cost of the present invention can be lowered. Besides, SAF has a low air entraining content, prevents excessive bleeding of concrete and has small impact on the setting time of concrete. However, liquid SAF is obviously red. After it is added into concrete, color bleeding can happen. It has large colour aberration from concrete. After it is mixed and takes graft reaction with calcium lignosulfonate, it becomes brown and has small colour aberration from concrete, so it is easily accepted by users.

The conditions of graft copolymerization reaction described in the present invention include all conditions that enable the lignosulfonate and carbonyl aliphatic compounds to take graft reaction. The above conditions principally relates to the mix, heating and graft reaction of aliphatics and modified lignin (lignosulfonate). The reaction ratio can be any ratio.

In this embodiment, lignosulfonates include calcium lignosulfonate, sodium lignosulfonate and magnesium lignosulfonate, and also can include a small amount of ammonium lignosulfonate, for example, the calcium lignosulfonate produced by Jilin Chenming Group. It can also be obtained from the sulfonation of black liquor of paper pulp under the initiation of H2O2-Fe2+. When the sulfonation is finished, the initiation system is not yet to lose effect. After it is mixed and heated with aliphatics, the unpolymerized unsaturated olefinic bonds will be initiated and grafted to modified lignosulfonate.

In this embodiment, the optional weight ratio is: carbonyl aliphatic water reducer:lignosulfonate=1:(0.75˜1). Its comprehensive performance as a water reducer is even better. The data are shown below. The preparation process of concrete water reducer is as follow: control the temperature of water reducer of aliphatics at 95-100° C. (for example at 97° C., 98° C. or 99° C.); drop lignosulfonate into water reducer of aliphatics; conduct graft copolymerization reaction; insulation work at 95-100° C. (for example 96° C., 98° C. or 99° C.) for 2-5 h (for example 2.5 h, 3 h, 3.5 h, 4 h or 4.5 h) and obtain lignosulfonate which then graft-modifies the aliphatics concrete water reducer.

### Embodiment 2

A lignosulfonate grafted carbonyl aliphatic concrete water reducer, which is prepared through graft copolymerization reaction between lignosulfonate and carbonyl aliphatic concrete water reducer. By weight, the proportioning of lignosulfonate grafted carbonyl aliphatic concrete water reducer is:

Carbonyl aliphatic compounds:lignosulfonate=1:(0.75˜1), for example, the optional ratio can be: 1:0.75, 1:0.8, 1:0.82, 1:0.85, 1:0.87, 1:0.92, 1:0.95, 1:0.97, 1:0.98, 1:0.99; and the preferable ratio is: 1:1.

The said concrete water reducer is prepared through the following steps: control the temperature of water reducer of aliphatics at 95-100° C. (for example 97° C., 98° C. or 99° C.), drop lignosulfonate into water reducer of aliphatics, conduct graft copolymerization reaction, insulation work at 95-100° C. (for example 96° C., 98° C. or 99° C.) for 2-5 h (for example 2.5 h, 3 h, 3.5 h, 4 h or 4.5 h) and obtain lignosulfonate modified and grafted aliphatics concrete water reducer.

Wherein, the carbonyl aliphatic concrete water reducer and lignosulfonate are available in the market. The lignosulfonates mainly include calcium lignosulfonate, sodium lignosulfonate and magnesium lignosulfonate and can also include a small amount of ammonium lignosulfonate, for example, the calcium lignosulfonate produced by Jilin Chenming Group. The high-performance aliphatics water reducer mainly refers to the SAF synthesized from acetone, sulphite and formaldehyde. Its structural feature is that the main chain of hydrophobic group is aliphatic hydrocarbon, while the hydrophilic groups mainly include —SO3H, —COOH and —OH. For example, Jiangsu TMS Concrete Addition Agent Co., Ltd. produces high-performance aliphatics series water reducers, such as SAF.

### Embodiment 3

This embodiment is same as Embodiment 2 in terms of raw material proportion and reaction conditions.

A lignosulfonate grafted carbonyl aliphatic concrete water reducer, of which proportion by weight is:

Carbonyl aliphatic concrete water reducer:lignosulfonate=1:(0.75˜1), for example, the optional ratio can be: 1:0.75, 1:0.8, 1:0.82, 1:0.85, 1:0.87, 1:0.92, 1:0.95, 1:0.97, 1:0.98, or 1:0.99; and the preferable ratio is: 1:1.

The said concrete water reducer is prepared through the following steps: control the temperature of water reducer of aliphatics at 95-100° C. (for example 97° C., 98° C. or 99° C.), drop lignosulfonate into water reducer of aliphatics, conduct graft copolymerization reaction, insulation work at 95-100° C. (for example 96° C., 98° C. or 99° C.) for 2-5 h (for example 2.5 h, 3 h, 3.5 h, 4 h or 4.5 h) and obtain lignosulfonate modified and grafted aliphatics concrete water reducer.

Different from Embodiment 2, this embodiment adopts the raw material prepared by the following method. After the raw material is produced, it is directly used to produce lignosulfonate grafted carbonyl aliphatic concrete water reducer and thus better grafting can be obtained. Compared with Embodiment 2, this embodiment has the following advantages: (1) after the raw material is produced, the modified lignosulfonate is obtained from the sulfonation of black liquor of paper pulp under the initiation of H2O2-Fe2+. After the sulfonation is finished, the initiation system is yet to lose effect. When it is mixed and heated with aliphatic compound, the unpolymerized unsaturated olefinic bonds will be initiated and grafted to modified lignosulfonate; in aliphatic, there is remnant formaldehyde. In alkaline environment, it will condense with modified lignosulfonate. This also improves the water solubility of water reducer. (2) the raw material produced by the following method has low cost. It utilizes industrial waste and paper making waste and is characterized by even lower cost and environmental friendliness. The method is also more simple.

### The Preparing Steps of the Raw Material are as Follows:

In this embodiment, carbonyl aliphatic compounds are produced through the following steps: mix the said water, anhydrous sulphite and acetone, rise in temperature to 56-100° C. (for example, the temperature can be 57° C., 58° C., 59° C., 60° C., 62° C., 64° C., 68° C., 75° C., 80° C., 85° C., 90° C., 95° C. or 98° C.), drop formaldehyde into the above mixed liquid in 0.5-2 h (it can be 1 or 1.5 h), insulation work at 100-103° C. (the temperature can be 101° C. or 102° C.) 1-4 h (the time can be 1.5 h, 2 h, 3 h or 3.5 h) and obtain aliphatics.

### Proportion of the Raw Materials in Preparing Carbonyl Aliphatic Compounds:

Anhydrous sulphite: its weight is 9-15% of the total weight of the four raw materials—water, anhydrous sulphite, acetone and formaldehyde. The ratio can be 11%, 11.5%, 12%, 12.5%, 13%, 14% or 14.5%; acetone: its weight is 9-15% of the total weight of the four raw materials—water, anhydrous sulphite, acetone and formaldehyde. The ratio can be 11%, 11.5%, 12%, 12.5%, 13%, 14% or 14.5%; formaldehyde: its weight is 9-40% of the total weight of the four raw materials—water, anhydrous sulphite, acetone and formaldehyde. The ratio can be 16%, 17%, 19%, 20%, 22%, 23%, 26%, 27%, 28%, 29%, 30%, 32%, 34% or 35%; Water: its weight is 35-65% of the total weight of the four raw materials—water, anhydrous sulphite, acetone and formaldehyde. The ratio can be 35%, 37%, 39%, 42%, 45.5%, 46%, 47%, 48%, 49%, 50%, 51%, 53%, 54%, 54.5%, 55%, 58%, 60%, 62% or 65%;

### Proportion of the Raw Materials in Preparing Lignosulfonate:

Thin black liquor of paper pulp: thin black liquor of paper pulp can be the waste liquid of paper making or comes from the waste liquid of straw pulp, bamboo pulp or reed pulp. The content of lignin can be 10%, or it can be concentrated into 30%-80% lignin black liquor before use, or it can be concentrated to another ratio by another method. The calculation is based on the solid content of lignin. During the calculation of the total mass of lignosulfonate, the mass of other part in thin black liquor of paper pulp except lignin is not considered. In other words, the total mass of lignosulfonate is the total mass of the following lignosulfonates: the lignin, heptahydrate-ferrous sulfate, anhydrous sulphite, ammonium persulfate and oxydol in thin black liquor of paper pulp. The mass of lignin is 50%-64% of the total mass of the five raw materials (can be: 51%, 52%, 53%, 56%, 57%, 58%, 59%, 60%, 61%, 62%, 63% or 64%); heptahydrate-ferrous sulfate: its mass is 0.2%-0.4% of the total mass of the five raw materials (can be: 0.22%, 0.3% or 0.35%); anhydrous sulphite: its mass is 35%-45% of the total mass of the five raw materials (can be: 36%, 38%, 39%, 42%, 43% or 44%); ammonium persulfate: its mass is 0.2%-0.4% of the total mass of the five raw materials (can be: 0.22%, 0.3% or 0.35%); oxydol: its mass is 0.2-0.4% of the total mass of the five raw materials (can be: 0.22%, 0.3% or 0.35%).

### The Lignosulfonate is Prepared Through the Following Steps:

Pre-homogenizing black liquor of paper pulp, rise in temperature to 75-85° C. (the temperature can be 76° C., 77° C., 78° C., 79° C., 80° C., 81° C., 82° C., 83° C. or 84° C.), add oxydol heptahydrate-ferrous sulfate, insulation work at 75-85° C. for 0.5-3 h and rise in temperature to 95° C. (the insulation work can be 76° C., 77° C., 78° C., 79° C., 80° C., 81° C., 82° C., 83° C. or 84° C.; the time can be 0.6 h, 1 h, 1.5 h, 2 h or 2.5 h), add ammonium persulfate and anhydrous sulphite, insulation work at 95-100° C. for 2-5 h (the temperature can be 96° C., 97° C., 98° C. or 99° C.; the time can be 2.5 h, 3 h, 3.5 h, 4 h or 4.5 h) and obtain lignosulfonate.

In this embodiment, in order to reduce cost, anhydrous sulphite can be from industrial waste residue.

The neutralization of sulphite waste liquid (residue) and the difference of the alkaline substances introduced during sulfonation of alkali lignin result in different cations in lignosulfonate. For example, Ca(OH)2, KOH, NaOH, Mg(OH)2 and ammonia can be used. Their corresponding lignosulfonates are calcium lignosulfonate, potassium lignosulfonate, sodium lignosulfonate, magnesium lignosulfonate and ammonium lignosulfonate. For example, Jilin Chenming Group produces calcium lignosulfonate, Tumen Chemical Co., Ltd. produces calcium lignosulfonate, Tianjin Lijian Special Building Material Co., Ltd. produces modified lignosulfonate, Honglin Chemical Co., Ltd. produces calcium (sodium) lignosulfonate, Henan produces lignosulfonate by alkaline process, Sichuan Qilongshan produces lignosulfonate (ammonia lignosulfonate) by ammonium process, and Guangzhou hangmen produces magnesium lignosulfonate.

### Embodiment 4

Same as Embodiment 3, wherein:

The proportion of the raw materials in preparing carbonyl aliphatic concrete water reducer can be:

| | Anhydrous | | | |
|---|---|---|---|---|
| Raw material | sulphite | Acetone | Formaldehyde | Water |
| Proportion 1 (%) | 11 | 13 | 33 | 45 |
| Proportion 2 (%) | 13 | 11 | 33 | 45 |
| Proportion 3 (%) | 13 | 13 | 35 | 39 |
| Proportion 4 (%) | 14 | 12 | 26 | 48 |
| Proportion 5 (%) | 15 | 11 | 18 | 56 |
| Proportion 6 (%) | 12 | 14 | 13 | 61 |
| Proportion 7 (%) | 11 | 11 | 15 | 63 |
| Proportion 8 (%) | 12 | 14 | 32 | 42 |

The proportion of the raw materials in preparing lignosulfonate can be: (lignin refers to the lignin in the thin black liquor of paper pulp)

| | | Hepta- | | | |
|---|---|---|---|---|---|
| | | hydrate- | Anhy- | Ammo- | |
| | Lignin | ferrous | drous | nium | |
| Raw material | content | sulfate | sulphite | persulfate | Oxydol |
| Proportion 1 (%) | 51 | 0.4 | 48 | 0.3 | 0.3 |
| Proportion 2 (%) | 58 | 0.3 | 41 | 0.3 | 0.4 |
| Proportion 3 (%) | 52 | 0.2 | 47 | 0.4 | 0.4 |
| Proportion 4 (%) | 53 | 0.3 | 46 | 0.3 | 0.4 |
| Proportion 5 (%) | 54 | 0.25 | 45 | 0.35 | 0.4 |
| Proportion 6 (%) | 55 | 0.4 | 44 | 0.3 | 0.3 |
| Proportion 7 (%) | 56 | 0.3 | 43 | 0.4 | 0.3 |
| Proportion 8 (%) | 57 | 0.2 | 42 | 0.4 | 0.4 |
| Proportion 9 (%) | 58 | 0.4 | 41 | 0.4 | 0.2 |
| Proportion 10 (%) | 59 | 0.3 | 40 | 0.4 | 0.3 |
| Proportion 11 (%) | 60 | 0.4 | 38.8 | 0.4 | 0.4 |
| Proportion 12 (%) | 61 | 0.2 | 38.2 | 0.2 | 0.4 |
| Proportion 13 (%) | 62 | 0.2 | 37.3 | 0.2 | 0.3 |
| Proportion 14 (%) | 63 | 0.4 | 35.8 | 0.4 | 0.4 |

### Embodiment 5

A lignosulfonate grafted carbonyl aliphatic concrete water reducer was prepared by the following method: mix the following two raw materials and conduct graft copolymerization reaction: 50 kg of carbonyl aliphatic concrete water reducer produced in Embodiment 3 and 50 kg of lignosulfonate produced in Embodiment 3; the method for the graft copolymerization of lignosulfonate grafted carbonyl aliphatic concrete water reducer: control the temperature of aliphatics concrete water reducer at 97° C., treat the above water reducer into liquid state, drop lignosulfonate to aliphatics concrete water reducer, heat to 98° C. and insulation work at 98° C. for 2 h, conduct graft copolymerization reaction and obtain lignosulfonate modified and grafted aliphatics concrete water reducer.

### Embodiment 6

A method for preparing concrete water reducer by grafting of lignosulfonate with carbonyl aliphatic compounds,

Preparation for lignosulfonate: homogenize black liquor of paper pulp, rise in temperature to 75-85° C. add oxydol (H2O2) and ferrous sulfate heptahydrate (FeSO4.7H2O), insulation work at 75-85° C. 0.5-3 h, rise in temperature to 95° C., add ammonium persulfate (NH4)2S2O8 and anhydrous sodium sulfite Na3SO03, insulation work at 95-100° C. for 2-5 h and obtain lignosulfonate.

Preparation for aliphatics concrete water reducer: heat water, anhydrous sodium sulfite Na3SO3 and acetone (CH3)2CO to 56° C.-100° C. drop formaldehyde (HCHO) 0.5-2 h, insulation work at 100-103° C. for 1-4 h and obtain aliphatics concrete water reducer.

Lignosulfonate modified and grafted aliphatics concrete water reducer: reduce temperature to 95° C.-100° C. drop the above lignosulfonate into the above aliphatics concrete water reducer (the dropping time can be 0.5-1 h), react at 95° C.-100° C. for 2-5 h and obtain lignosulfonate modified and grafted aliphatics concrete water reducer.

Proportion and parameters of the above materials (Industrial grade raw materials are adopted. The proportion consults with Embodiment 3):

### I. Raw Materials Adopted by Carbonyl Aliphatic Concrete Water Reducer:

1) Anhydrous sulphite (Na2SO3): industrial grade, content≧93%,
2) Acetone ((CH3)2CO): industrial grade, content≧99%,
3) Formaldehyde (HCHO): industrial grade, content≧37%,
4) Water: Water for industrial use.
II. Proportion in the Production of Lignosulfonate from Black Liquor of Paper Pulp

The total mass of lignosulfonate includes the total mass of the lignin, heptahydrate-ferrous sulfate, anhydrous sulphite, ammonium persulfate and oxydol (calculation is based on pure oxydol).
(1) Thin black liquor of paper pulp: Calculated based on the solid content of lignin, the mass of lignin is 50%-64% of the mass of the lignosulfonate to be produced. In the thin black liquor of paper pulp, the solid content of lignin is 8-11%, or other concentration. Even concentrated black liquor can be adopted.
(2) Ferrous sulfate heptahydrate (FeSO4.7H2O): The net content of ferrous sulfate heptahydrate is 0.2-0.4% of the lignosulfonate which to be prepared. Usually, industrial grade ferrous sulfate heptahydrate is used.
(3) Anhydrous sodium sulphite (Na2SO3): The net content of anhydrous sodium sulphite is 35-49% of the lignosulfonate which to be prepared. Usually, industrial grade anhydrous sulphite is used, and its purity is ≧93%.
(4) Ammonium persulfate ((NH4)2S2O8): The net content of ammonium persulfate is 0.2-0.4% of the lignosulfonate which to be prepared. Usually, industrial grade ammonium persulfate is used, and its purity is ≧98%.
(5) Oxydol (H2O2): The net content of oxydol is 0.2-0.4% of the lignosulfonate which to be prepared. Usually, industrial grade oxydol is used, and its purity is 30%.

### III. Proportion in the Graft Copolymerization Between Lignosulfonate and Carbonyl Aliphatic Concrete Water Reducer

Carbonyl aliphatic compounds:lignosulfonate intermediate (as of solid)=1:(0.75-1)

In this embodiment, in order to reduce cost, anhydrous sulphite can be from industrial waste residue. In addition, the adoption of industrial grade raw materials also further reduces cost.

### Embodiment 7

Performance test of the new-type lignosulfonate grafted carbonyl aliphatic water reducer produced by method of Embodiment 3: the following graft is the water reducer produced in the present invention. (The modified lignin below refers to lignosulfonate. Graft refers to the graft copolymer obtained in the present invention)

### 1. Raw Materials for the Test:

TABLE 1
Raw materials used in this embodiment

| Raw material | Brand and grade |
|---|---|
| Cement | Conch PO42.5 |
| | United PO42.5 |
| | Jingyang PO42.5 |
| | Reference cement in national admixture |
| | standard |
| Ground slag | S95 ground slag |
| Fly ash | Grade II fly ash |
| Low-quality black | Zhenjiang Pulp Mill |
| liquor of paper pulp | |
| Lignosulfonate | Lignin intermediate produced by Jiangsu TMS |
| | Comcreate Addition Agent Co., Ltd. |
| | Calcium lignosulfonate produced by Jilin |
| | Chenming Group |
| | Kenal liquid lignosulfonate KNLS-L |
| | Kenal powdery lignosulfonate KNLS-S |
| | Imported sodium lignosulfonate water reducer |
| | Imported calcium lignosulfonate water reducer |
| Aliphatics series | Produced by Jiangsu TMS Comcreate Addition |
| high-performance | Agent Co., Ltd. |
| water reducer | |
| Lignin grafted | New-type concrete admixtures produced by |
| carbonyl aliphatic | Jiangsu TMS Comcreate Addition Agent Co., |
| water reducer | Ltd. |
| Standard sand | Standard sand used in ISO cement mortar |
| | strength test |
| Fine aggregate | Yellow sand (fineness modulus 2.5-3.0) |
| Coarse aggregate | Gravel (5-25 mm) |
| Others | Air entraining agent (paste AES-1 and powder |
| | AES-2) |
| | Sodium gluconate, sodium citrate, |
| | polycarboxylic acid series water reducer, and so |
| | on |

### 2. Test Method

1) Paste fluidity is determined according to GB8077-2000 Methods for testing uniformity of concrete admixture.
2) The setting time of cement paste is determined according to GB/T 1364-2001 Standard test method for water requirement for normal consistency setting time and soundness of the portland cement.
3) The performance test of the concrete with admixtures shall be done according to GB8076-1997 Concrete Admixtures.
4) Other concrete tests shall be done according to GB81-1985 Standard for test method of mechanical properties on ordinary concrete.

### 3. Test Results

### (1) Test of Solid Content

The test result of the solid content of the lignin grafted carbonyl aliphatic water reducer in the present invention is shown in Table 2.

TABLE 2
Concentration of raw materials and product

| Product | Concentration (%) |
|---|---|
| Stock solution of pulp | 18.7 |
| Lignosulfonate | 28.9 |
| Carbonyl aliphatic water reducer | 31.1 |
| Lignin grafted carbonyl aliphatic water reducer | 32.6 |

### (2) Analysis on the Basic Properties and Molecular Characteristics of Water Reducer

The basic properties of lignin grafted carbonyl aliphatic water reducer are shown in Table 3.

TABLE 3
Basic physicochemical indicators of lignin grafted carbonyl
aliphatic water reducer

| Item | |
|---|---|
| Appearance | Reddish brown liquid |
| Specific gravity (20° C.) | 1.1 |
| Solid content | 32.6 |
| pH value | |
| Water insoluble | |
| Reducing sugar | |
| Reducer | |
| Content of chlorine ions | |
| Content of sodium sulfate | |

The infra-red spectrums of black liquor of paper pulp, lignosulfonate intermediate, carbonyl aliphatic water reducer and lignin-carbonyl aliphatic grafted product are shown in attached drawings. From the analysis of the infra-red spectrums, the spectrogram of the graft is basically the superposition of the two spectrograms of carbonyl aliphatic water reducer and modified lignin, suggesting functional groups are not changed. The difference is that carbonyl group aliphatic has a C═C absorption peak at 1625 cm−1, while in the spectrogram of the graft, the peak of C═C absorption peak (appearing position: 1680-1620 cm−1) disappears.

Ubbelohde viscometer is adopted to determine the intrinsic viscosity of a few samples. The results are shown in Table 4.

TABLE 4
Results of viscosity test

| No. | Water reducer | [η]ml/g |
|---|---|---|
| A | Aliphatics concrete water reducer | 8.26 |
| B | Cold combination of aliphatics and modified lignin | 7.44 |
| C | Lignin grafted carbonyl aliphatic water reducer | 6.17 |
| D | Modified lignin | 5.68 |

Note:
The proportioning of cold combination in B is consistent with that of the two materials in C

In combination with infra-red spectrum and viscosity analysis, the results indicate:
a. In carbonyl aliphatic water reducer, there exists the condensation product containing C═C. It is grafted to modified lignosulfonate. The production process of graft is to mix and heat aliphatics and modified lignin. The modified lignosulfonate is obtained from the sulfonation of black liquor of paper pulp under the initiation of H2O2-Fe2+. After the sulfonation is finished, the initiation system is not yet to lose effect. When it is mixed and heated with aliphatics, the unpolymerized unsaturated olefinic bonds will be initiated and grafted to modified lignosulfonate. This inference is verified in viscosity test. The intrinsic viscosity of polymer has to do with its molecular weight and molecular structure. When the structure is similar, the larger the molecular weight is, the higher the viscosity will be; when molecular weight is similar, the viscosity of chain structure is higher than that of star-shape branch structure. The reaction between aliphatics and modified lignin tends to become stable and the change of molecular weight is not large; aliphatic has a chain structure, its effective hydrodynamic volume is large and viscosity is high accordingly, whereas when the chain structure containing C═C is grafted to modified lignin, the chain structure will decrease and meanwhile the degree of branching of modified lignin will increase and the viscosity will decrease accordingly. In viscosity test, the viscosity of Group C is lower than that of Group B.
b. In carbonyl aliphatic compounds, there is remnant formaldehyde. In alkaline environment, it will condense with modified lignosulfonate. This improves the water solubility of water reducer.

### (3) The Law of the Influence of Water Reducer on the Fluidity of Cement Paste

The influence of carbonyl aliphatic water reducer, cold combination of carbonyl aliphatic compounds and modified lignin water reducer, and lignin grafted carbonyl aliphatic water reducer on the fluidity of two cement pastes is compared. Unless otherwise specified, the dosage of admixtures is expressed with the mass fraction of solid to cement (the same below). The results are shown in Table 5.

TABLE 5
Influence of three water reducers on the fluidity of cement paste

| | | | | |
|---|---|---|---|---|
| | Type of water | Dosage of water | Amount of | |
| No. | reducer | reducer/% | added water/g | Fluidity/mm |

Reference cement 300 g

| | | | | |
|---|---|---|---|---|
| 1 | Aliphatics | 0.2 | 87 | 88 |
| 2 | — | 0.3 | — | 253 |
| 3 | — | 0.4 | — | 272 |
| 4 | — | 0.5 | — | 280 |
| 5 | Graft | 0.2 | 87 | 110 |
| 6 | — | 0.3 | — | 252 |
| 7 | — | 0.4 | — | 266 |
| 8 | — | 0.5 | — | 272 |
| 9 | Cold | 0.2 | 87 | 82 |
| | combination | | | |
| 10 | — | 0.3 | — | 234 |
| 11 | — | 0.4 | — | 261 |
| 12 | — | 0.5 | — | 268 |

Conch cement 300 g

| | | | | |
|---|---|---|---|---|
| 1 | Aliphatics | 0.2 | 87 | 116 |
| 2 | — | 0.3 | — | 222 |
| 3 | — | 0.4 | — | 279 |
| 4 | — | 0.5 | — | 283 |
| 5 | Graft | 0.2 | 87 | 107 |
| 6 | — | 0.3 | — | 191 |
| 7 | — | 0.4 | — | 261 |
| 8 | — | 0.5 | — | 281 |
| 9 | Cold | 0.2 | 87 | 93 |
| | combination | | | |
| 10 | — | 0.3 | — | 161 |
| 11 | — | 0.4 | — | 265 |
| 12 | — | 0.5 | — | 270 |

From Table 5, it can be seen that when the dosage of water reducer is same, graft has better fluidity than the cold-combined water reducer and is slightly inferior to carbonyl aliphatic water reducer.

### (4) Law of the Influence of Water Reducer on Fluidity Retentivity of Cement Paste

The law of the influence of aliphatics water reducer, cold-combined aliphatics and modified lignin water reducer, and lignin grafted carbonyl aliphatic water reducer on fluidity retentivity of two cement pastes is compared. The results are shown in Table 6 and attached drawings.

TABLE 6
Fluidity loss test

| | | | Dosage | Amount | | | |
|---|---|---|---|---|---|---|---|
| | Type of | Dosage | of | of | | | |
| | water | of water | liquid | added | Fluidity/mm | | |
| No. | reducer | reducer/% | agent/g | water/g | Initial | 0.5 h | 1 h |

Conch cement 400 g

| | | | | | | | |
|---|---|---|---|---|---|---|---|
| 1 | Aliphatics | 0.3 | 3.86 | 123 | 270 | 113 | — |
| 2 | — | 0.35 | 4.51 | 118 | 285 | 134 | — |
| 3 | — | 0.4 | 5.15 | 112.5 | 285 | 130 | 85 |
| 4 | — | 0.45 | 5.80 | 110 | 295 | 182 | 112 |
| 5 | Graft | 0.3 | 3.69 | 140 | 270 | 190 | 180 |
| 6 | — | 0.35 | 4.30 | 132 | 280 | 190 | 152 |
| 7 | — | 0.4 | 4.92 | 120 | 275 | 171 | 140 |
| 8 | — | 0.45 | 5.53 | 115 | 282 | 185 | 152 |
| 9 | Cold | 0.3 | 3.93 | 145 | 272 | 167 | 145 |
| | combination | | | | | | |
| 10 | — | 0.35 | 4.58 | 135 | 290 | 164 | 142 |
| 11 | — | 0.40 | 5.23 | 116 | 271 | 101 | — |
| 12 | — | 0.45 | 5.88 | 114 | 273 | 152 | — |

Reference cement 400 g

| | | | | | | | |
|---|---|---|---|---|---|---|---|
| 1 | Aliphatics | 0.35 | 4.51 | 116 | 280 | 160 | — |
| 2 | Graft | 0.35 | 4.30 | 118 | 282 | 195 | 146 |
| 3 | Cold | 0.35 | 4.58 | 123 | 278 | 190 | 127 |
| | combination | | | | | | |

The fluidity loss of Conch cement paste in 0.5 h and the results of fluidity loss test indicate that when initial fluidity is similar, the paste with graft water reducer will be better than that with cold-combined water reducer and that with aliphatics water reducer in terms of the retentivity of paste fluidity.

(5) Performance Comparison of the Concrete with Water Reducer

The mix ratio and initial slump of the concrete produced by using SAF, graft, the admixture that combines modified lignin and SAF (1:3.5) in cold, and the water reducing ratio of concrete admixtures is shown in Table 7. The corresponding compressive strength is shown in Table 8:

TABLE 7
Water reducing ratio of concrete admixtures

| | | | | | | | | Water |
|---|---|---|---|---|---|---|---|---|
| | | Mix ratio/kg · m-3 | | | | | | reducing |
| No. | Admixture | C | W | S | G | Admixture | Slump/mm | ratio |
| A1 | Reference | 330 | 210 | 724 | 1181 | | 72 | |
| A2 | SAF | 330 | 170 | 724 | 1181 | 0.5% | 60 | 19.0% |
| A3 | Graft | 330 | 170 | 724 | 1181 | 0.5% | 65 | 19.0% |
| A4 | Cold | 330 | 175 | 724 | 1181 | 0.5% | 65 | 16.7% |
| | combination | | | | | | | |

TABLE 8
Compressive strength of concrete

| | Compressive strength/MPa | | |
|---|---|---|---|
| No. | 3 d | 7 d | 28 d |
| A1 | 12.9/100 | 22.5/100 | 31.4/100 |
| A2 | 22.3/173 | 33.9/151 | 47.0/150 |
| A3 | 18.3/142 | 29.2/129 | 38.9/124 |
| A4 | 16.3/126 | 26.7/119 | 38.4/122 |

From Table 7 and Table 8, it can be seen that the concrete produced with graft is superior to the concrete produced with the cold combination of modified black liquor of paper pulp and SAF in terms of water reducing ratio and compressive strength of concrete, but it is inferior to SAF in terms of strength development of concrete.

(6) Performance Comparison of the Concrete with Combined Water Reducer

The mix ratio and initial, 30 min, 1 h and 2 h slumps of the concrete produced with graft, graft+sodium gluconate, and the admixture that combines modified lignin and SAF (1:3.5) in cold are shown in Table 9. The corresponding compressive strength is shown in Table 10:

TABLE 9
Concrete slump test

| | | Concrete mix ratio/kg · m-3 | | | | | Slump/mm | | | |
|---|---|---|---|---|---|---|---|---|---|---|
| No. | Admixture | C | W | S | G | Admixture | 0 h | 30 m | 1 h | 2 h |
| C1 | Reference | 390 | 260 | 799 | 1016 | | 200 | — | — | — |
| C2 | Graft | 390 | 218 | 799 | 1016 | 0.4% | 200 | 170 | 130 | 85 |
| C3 | Graft + sodium | 390 | 190 | 799 | 1016 | 0.4% + 3/10000 | 205 | 90 | — | — |
| | gluconate | | | | | | | | | |
| C4 | Graft + sodium | 390 | 195 | 799 | 1016 | 0.4% + 5/10000 | 200 | 85 | — | — |
| | gluconate | | | | | | | | | |
| C5 | Cold | 390 | 200 | 799 | 1016 | 0.4% | 196 | 90 | — | — |
| | combination | | | | | | | | | |

TABLE 10
Compressive strength of concrete

| | Compressive strength/MPa | | |
|---|---|---|---|
| No. | 3 d | 7 d | 28 d |
| C1 | 11.7/100 | 20.1/100 | 28.5/100 |
| C2 | 21.5/184 | 32.2/160 | 38.0/134 |
| C3 | 23.5/200 | 32.9/164 | 46.1/162 |
| C4 | 18.4/157 | 35.5/177 | 41.1/144 |
| C5 | 22.5/192 | 34.2/170 | 40.9/144 |

From Table 9, it can be seen that the concrete produced with graft has better slump loss in comparison with the concrete produced with combined SAF and meets pumping requirement 2 h later. Meanwhile, it can also be seen that the combination of sodium gluconate on the basis of graft creates even better water reducing effect for concrete, but impairs slump loss of concrete.

### (7) Use Lignin Grafted Carbonyl Aliphatic Water Reducer to Produce C30, C40 and C50 Concrete

The combination of hot polymer and sodium gluconate is used to produce C30, C40 and C50 concrete by adopting a simple cementitious system and a cement-ground slag-fly ash cementitious system, respectively. The test data are shown in Table 11 and Table 12:

TABLE 11
Slump of the produced concrete

| | | Concrete mix ratio/kg · m-3 | | | | | | | |
|---|---|---|---|---|---|---|---|---|---|
| No. | Admixture | C | SL | FA | W | S | G | Admixture | Slump/mm |
| D1 | Graft + sodium | 280 | | 70 | 180 | 789 | 1046 | 0.4% + 5/10000 | 180 |
| | gluconate | | | | | | | | |
| D2 | — | 320 | | 80 | 175 | 750 | 1036 | 0.4% + 5/10000 | 220 |
| D3 | — | 384 | | 96 | 170 | 681 | 1021 | 0.4% + 5/10000 | 220 |
| D4 | — | 200 | 80 | 120 | 180 | 791 | 1049 | 0.4% + 3/10000 | 195 |
| D5 | — | 220 | 110 | 110 | 180 | 774 | 1026 | 0.4% + 3/10000 | 210 |
| D6 | — | 250 | 125 | 125 | 185 | 748 | 992 | 0.4% + 3/10000 | 200 |

TABLE 12
Compressive strength of the produced concrete

| | Compressive | | |
|---|---|---|---|
| | strength/MPa | | |
| No. | 3 d | 7 d | 28 d |
| D1 | 16.9 | 27.7 | 36.8 |
| D2 | 20.0 | 36.1 | 40.8 |
| D3 | 26.9 | 38.9 | 47.9 |
| D4 | 14.4 | 32.2 | 42.3 |
| D5 | 19.4 | 39.4 | 49.5 |
| D6 | 26.3 | 44.9 | 58.4 |

From Table 11 and Table 12, it can be seen that the concrete produced by using graft and cement-ground slag-fly ash cementitious system can meet the strength requirements of C30, C40 and C50.

1. A method for preparing concrete water reducer by grafting of lignosulfonate with carbonyl aliphatics, wherein the water concrete is obtained through graft copolymerization reaction between lignosulfonate and carbonyl aliphatic compounds.

2. A method for preparing concrete water reducer by grafting of lignosulfonate with carbonyl aliphatics according to claim 1, wherein the weight ratio between said carbonyl aliphatic compounds and said lignosulfonate is 1:(0.75˜1).

3. A method for preparing concrete water reducer by grafting of lignosulfonate with carbonyl aliphatics according to claim 2, wherein the conditions of graft copolymerization reaction: drop said lignosulfonate into said carbonyl aliphatic compounds and conduct graft copolymerization reaction at 95° C.-100° C. for 2-5 h.

4. A lignosulfonate grafted carbonyl aliphatic concrete water reducer according to claim 3, wherein said carbonyl aliphatic compounds are obtained through the following steps: mix water, anhydrous sulphite and acetone, rise in temperature to 56° C.-100° C., drop formaldehyde into the above mixed liquid for 0.5˜2 h and insulation work at 100° C.-103° C. for 1-4 h and obtain carbonyl aliphatic compounds, and wherein the proportion of the above raw materials is anhydrous sulphite: 9%-15% of the total weight of the four raw materials including water, anhydrous sulphite, acetone and formaldehyde; acetone: 9-15% of the total weight of the four raw materials; formaldehyde: 9%-40% of the total weight of the four raw materials; water: 35%-65% of the total weight of the four raw materials.

5. A lignosulfonate grafted carbonyl aliphatic concrete water reducer according to claim 3, wherein a production method of the lignosulfonate includes pre-homogenize black liquor of paper pulp, add oxydol and heptahydrate-ferrous sulfate, react at 75° C.-85° C. for 0.5˜3 h, control temperature at 95° C.-100° C., add ammonium persulfate and anhydrous sulphite, further react for 2-5 h and obtain lignosulfonate, and wherein the proportion of the above raw materials black liquor of paper pulp: calculated based on the weight of lignin, the weight of lignin is 50%-64% of the total weight of lignin, oxydol, heptahydrate-ferrous sulfate, ammonium persulfate and anhydrous sulphite; oxydol: its weight is 0.2%-0.4% of the total weight; heptahydrate-ferrous sulfate: its weight is 0.2%-0.4% of the total weight; ammonium persulfate: its weight is 0.2%-0.4% of the total weight; anhydrous sulphite: its weight is 35%-49% of the total weight.

6. A lignosulfonate grafted carbonyl aliphatic concrete water reducer according to claim 5, wherein the product obtained from the production of lignosulfonate and carbonyl aliphatic compounds by the above method immediately conducts graft copolymerization reaction under the given grafting conditions.

7. A method for preparing concrete water reducer by grafting of lignosulfonate with carbonyl aliphatics according to claim 5, wherein anhydrous sulphite is industrial waste residue anhydrous sodium sulphite.

8. A method for preparing concrete water reducer by grafting of lignosulfonate with carbonyl aliphatics according to claim 3, wherein carbonyl aliphatic compounds are sulfonated acetone-formaldehyde (SAF) based water reducer.

9. A method for preparing concrete water reducer by grafting of lignosulfonate with carbonyl aliphatics according to claim 5, wherein black liquor of paper pulp comes from the waste liquid of straw pulp, bamboo pulp and reed pulp.

10. A method for preparing concrete water reducer by grafting of lignosulfonate with carbonyl aliphatics according to claim 5, wherein black liquor of paper pulp is the thin black liquor of paper pulp directly discharged from factories, and the concentration of the thin black liquor is 8%-11%.

11. A method for preparing concrete water reducer by grafting of lignosulfonate with carbonyl aliphatics according to claim 1, wherein carbonyl aliphatic compounds directly are the carbonyl aliphatic water reducer available in the market, and the lignosulfonate directly is the lignosulfonate modified water reducer available in the market.

12. A method for preparing concrete water reducer by grafting of lignosulfonate with carbonyl aliphatics according to claim 9, wherein black liquor of paper pulp is the thin black liquor of paper pulp directly discharged from factories, and the concentration of the thin black liquor is 8%-11%.

13. A method for preparing concrete water reducer by grafting of lignosulfonate with carbonyl aliphatics according to claim 2, wherein carbonyl aliphatic compounds directly are the carbonyl aliphatic water reducer available in the market, and the lignosulfonate directly is the lignosulfonate modified water reducer available in the market.

14. A method for preparing concrete water reducer by grafting of lignosulfonate with carbonyl aliphatics according to claim 3, wherein carbonyl aliphatic compounds directly are the carbonyl aliphatic water reducer available in the market, and the lignosulfonate directly is the lignosulfonate modified water reducer available in the market.
